(19) United States
(12) Patent Application Publication
(10) Pub. No.: US 2012/0318873 A1
(43) Pub. Date: Dec. 20, 2012

(54) Book With Concealed Signal Responsive Tag

(75) Inventor: Dale Hunt Nichols, SR., Nashville, TN (US)

(73) Assignee: SMARTGUARD, LLC, Nashville, TN (US)

(21) Appl. No.: 13/162,418

(22) Filed: Jun. 16, 2011

(51) Int. Cl. G06K 19/07; B42C 19/00

(52) U.S. Cl. 235/492; 412/4

(57) ABSTRACT

A book product having a sheet defining spaced-apart front and back covers and a spine portion therebetween having a laydown area that receives a signal responsive tag, and a book block of pages with an adhesive layer on a spine side that cooperatively attaches the pages together and attaches the book block to the spine portion concealing the signal responsive tag within a first thickness of the adhesive in the laydown area and the adhesive having a second thickness of adhesive in the non-laydown area of the spine, with the concealed signal responsive tag being responsive to a signal for inventory or security purposes.

### TECHNICAL FIELD

The present invention relates to books. More particularly, the present invention relates to soft cover books with a concealed signal responsive tag for inventory or security purposes.

### BACKGROUND OF THE INVENTION

Shrinkage of inventory of articles offered in retail sales is a continuing and expensive problem for retailers. Shrinkage arises primarily from theft of inventory. To deter theft, inventory tracking devices often are attached to the article or the package for the article, which articles are particularly susceptible to pilferage and improper removal from a warehouse or retail store. The inventory tracking devices include acoustic magnetic security strips and radio frequency response tags. These devices are embodied in tags, pods, labels, or patches. The strips and tags may have a pressure sensitive adhesive surface for attaching the inventory tracking device to the article or package. The inventory tracking device includes a detectable sensor. One known type of tag has a circuit that resonates at a predetermined detection frequency range. A transmitter provides electromagnetic energy that excites the circuit. A receiver detects the output signal from the resonating circuit. The transmitter and the receiver are located at detection points, often exits from retail facilities. As the article with the inventory tracking device is carried through the detection point, the receiver signals an alert when the device is activated in response to an interrogation signal from the transmitter. For articles that are permitted to pass (such as purchased articles), a separate device is used to deactivate the detectable sensor prior to passage. Other devices include RFID devices that communicate digital signals. In some known RFID devices, the signal is indicative of unique identifiers for tracking particular containers. Moreover, thin-film RFID devices have recently been developed that provide very thin device configurations.

Often large retailers require manufacturers of articles to include tracking and monitoring devices with the article or package. For smaller retailers and smaller inventories of articles, the tracking and monitoring devices may not be included. In such circumstances, the articles may be provided with after-market tracking and monitoring devices. For example, electronic article surveillance tags are available with adhesive backing to secure the tags to the articles or containers. Manual tagging of articles however is time consuming and removes sales personnel from customer service activities.

While the articles are then subject to article tracking and surveillance, the adhesively attached tags experience problems during use. One significant problem is that the tags, being on the exterior of the article or package, are susceptible to observation and removal. Removing the tag facilitates unauthorized removal of the article from the secured area. However, removal by a purchaser also causes problems. The covering to which the security tag attaches may become torn or ripped. The package with the security tag, or without such by removal, is unattractive. The security tag may also overlie or cover over ornamental graphics or text on the packaging. Mass produced “soft cover” books present difficulties in attaching inventory tracking and security tags. Such books have thin covers (for example, about 6 point to about 24 point thickness). A tag that projects above a planar surface of the cover causes the books to be difficult to group together in boxes for shipping. The visible tag may be removed either intentionally or inadvertently during handling. After-manufacturing placement of a tag on an inside cover or back cover is time consuming. The book has adhesive in the spine that binds together the pages in the book block, but unlike hard cover books, there is no gap to receive a tag.

Accordingly there is a need in the art for providing book products with a concealed signal responsive tag for inventory and security purposes. It is to such that the present invention is directed.

### SUMMARY OF THE INVENTION

The present invention meets the need in the art by providing a book product, in which a cover sheet pre-cut to a selected size defines in portions thereof spaced-apart opposing front cover and back cover for the book product, and defines a spine portion between the two portions for the front cover and the back cover. The spine portion defines a laydown area comprising less than a majority of the spine portion and a residual non-laydown area. The front cover and the back cover are foldable towards each other along respective spaced-part lines defined by the spine portion. A book block having a plurality of pages attaches together with a first adhesive layer on a spine side of the book block and the first adhesive layer cooperatively attaches to the spine portion of the cover sheet. A signal responsive tag for inventory or security purposes attaches with a second adhesive layer to the spine portion in alignment with the laydown area of the spine portion, whereby the signal responsive tag is disposed between the spine portion and the spine side of the book block for concealing the signal responsive tag from indication of its presence and being held within the first adhesive layer after attachment of the book block to the outer cover safely and securely therein during manufacture of the book product and during normal use thereof for book product purposes. The first adhesive layer between the spine portion and the spine side of the book block has a first thickness in the laydown area of the spine and a second thickness in the non-laydown area of the spine, the first thickness of adhesive less than the second thickness of adhesive and the first thickness of adhesive plus a thickness of the signal responsive tag substantially the same as the second thickness. The signal responsive tag for being responsive to a signal while the opposing portions of the cover sheet that define the front cover and back cover are moveable together and apart foldably along the lines defined by opposing sides of the spine portion while supporting and enclosing the book block within the book product. In another aspect, the present invention provides a method of manufacturing a book product, comprising the steps of:

(a) providing cover sheet pre-cut to a selected size and defining in portions thereof spaced-apart opposing front cover and back cover for the book product, and defining a spine portion between the two portions for the front cover and the back cover, the spine portion defining a laydown area and a residual non-laydown area, the front cover and the back cover foldable along respective spaced-part lines defined by the spine portion;

(b) attaching a signal responsive tag for inventory or security purposes to the spine portion in alignment with the laydown area of the spine portion

(c) binding a plurality of pages together with an adhesive layer applied on a spine side thereof to form a book block;

(d) cooperatively attaching the book block to the spine portion of the liner sheet so that the signal responsive tag is encased within the adhesive layer and held between the spine portion and the spine side of the book block in alignment with the laydown area of the spine portion during manufacture of the book product and during normal use thereof for book product purposes for concealing the signal responsive tag from casual indication of its presence, the adhesive layer thereafter having a first thickness in the laydown area of the spine and a second thickness in the non-laydown area of the spine, the first thickness of adhesive less than the second thickness of adhesive and the first thickness of adhesive plus a thickness of the signal responsive tag substantially the same as the second thickness,

whereby the signal responsive tag being responsive to a signal while the opposing portions of the cover sheet that define the front cover and back cover move together foldably along the lines defined by opposing sides of the spine portion for supporting and enclosing the bound assembly within the book product.

Objects, advantages and features of the present invention will become apparent from reading of the following detailed description of the invention and claims in view of the appended drawings.

### BRIEF DESCRIPTION OF THE DRAWINGS

FIG. 1 illustrates in perspective partially cut-away view of book product in which a signal responsive tag (illustrated exploded away) attaches between a cover sheet and a book block.

FIG. 2 illustrates in cross-sectional view of the book product taken along line 2-2 in FIG. 1 to illustrate features of the book product.

FIG. 3 illustrates in plan view of a cover sheet with the signal responsive tag illustrated exploded away for use with the book products illustrated in FIG. 1.

FIG. 4 illustrates a schematic block diagram for manufacture of the book product illustrated in FIG. 1.

FIG. 5 illustrates an alternate embodiment of the book product.

FIG. 6 illustrates an alternate embodiment of the signal responsive tag applied to the spine portion of the cover sheet.

### DETAILED DESCRIPTION

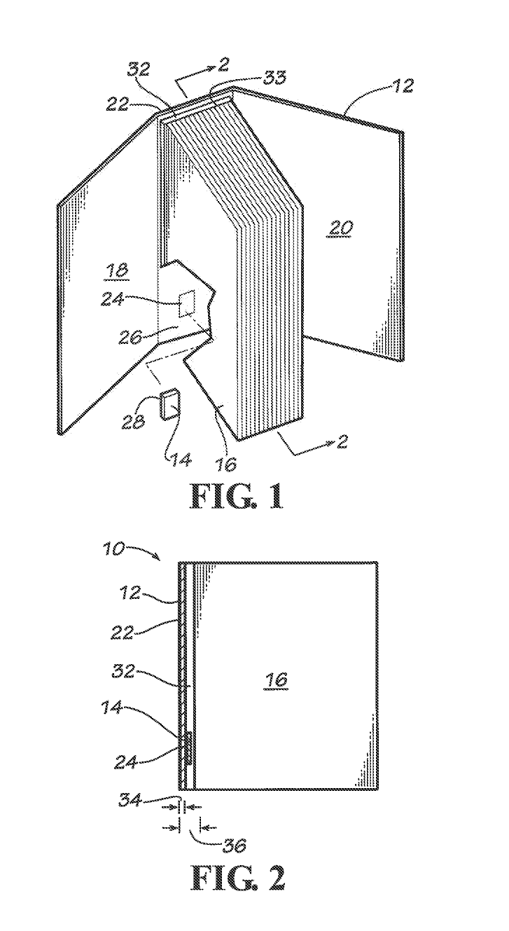

Referring now in more detail to the drawings in which like numerals refer to like parts throughout the several views, FIG. 1 illustrates in perspective partially cut-away view a book product 10 that includes a cover 12 to which a signal responsive tag 14 for inventory or security purposes (illustrated exploded away) attaches between the cover and a book block 16. The cover 12 is a sheet of a cover material that is pre-cut to a selected size. The cover 12 defines in spaced-apart portions a front cover 18 and an opposing back cover 20 for the book product 10. The cover 12 also defines a spine portion 22 between the two portions for the front cover 18 and the back cover 20. The spine portion 22 defines a laydown area 24 comprising a minority area of the spine portion and a residual non-laydown area 26. The front cover 18 and the back cover 20 are foldable towards each other along respective spaced-part lines defined by the spine portion 22.

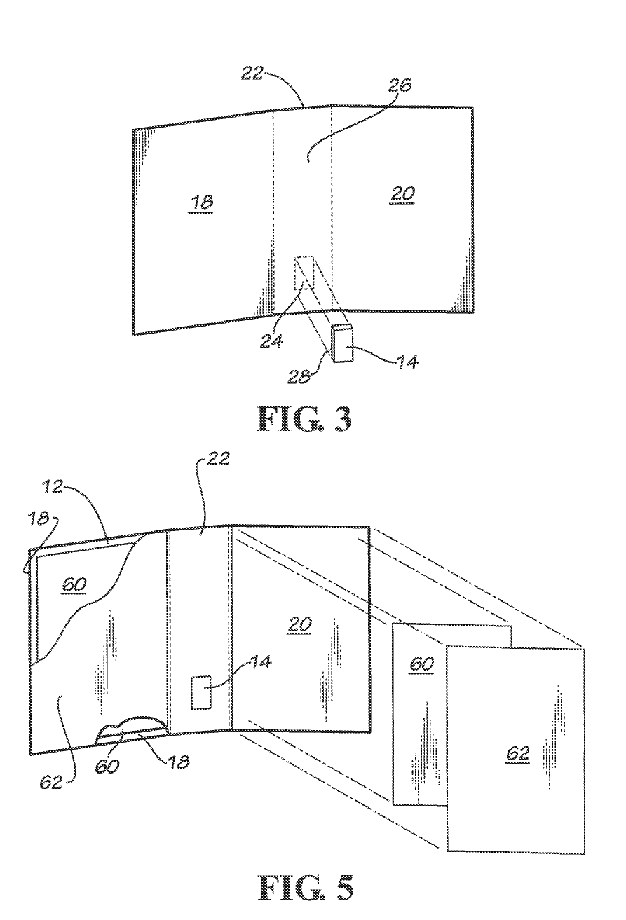

As illustrated in FIG. 3, the signal responsive tag 14 attaches to the laydown area 24 with a second adhesive layer 28. The second adhesive layer is a pressure-sensitive adhesive for providing a plurality of such tags on a web for use during manufacture of the book product 10. An applicator device receives the web, removes one of the tags attached to the web, transfers the removed tag into contact with the cover 12, and presses the tag into attachment in the laydown area 24.

With continuing reference to FIG. 1, the book block 16 includes a plurality of pages 30. The pages 30 collate together and a first adhesive layer 32 on a spine side 33 of the book block 16 attaches the pages together in the book block. The first adhesive layer 32 further cooperatively attaches to the spine portion 22 of the cover 12. As best illustrated in cross-sectional view in FIG. 2 taken on line 2-2 of FIG. 1, the first adhesive layer 32 between the spine portion 22 and the spine side 33 of the book block 16 has a first thickness 34 in the laydown area 24 of the spine and a second thickness 36 in the non-laydown area 26 of the spine. As discussed below, the first thickness 34 of adhesive is less than the second thickness 36 of adhesive, and generally, the first thickness of adhesive plus a thickness of the signal responsive tag 14 is substantially the same as the second thickness. In this way, the adhesive layer 32 has uniform thickness across the spine portion 22 and the exterior side of the cover 12 has a uniform appearance that does not indicate the inward presence of the signal responsive tag 14 embedded in the adhesive layer between the spine 22 and the spine side 33 of the book block 16, so that the signal responsive tag is concealed within the book 10 yet not providing an observable indication of its presence.

The signal responsive tag 14 responds to an inquiry signal communicated from an information apparatus. Signal responsive tags 14 include both passive and active tags of a type conventionally used for product inventory or security purposes. These tags include EAS, RF, AM, and RFID or other such inventory and security devices. Passive tags respond to a detection signal from an information apparatus while active tags include a microprocessor that may be programmed to communicate information to an interrogator in response to a signal from the interrogator. The information apparatus includes presence detectors and inventory tracking devices. A presence detector may communicate a signal generally in a small area such as around an exit door of a store. If the book product 10 is carried through the detector area without first deactivating the signal response tag 14, the tag upon receiving the signal provides a response signal, sound, or alert. The store personnel are thereby alerted to a possible theft of the book product 10. Other detector devices include product bar code scanners at product purchasing stands or registers. These devices may deactivate the signal response tag 14 while receiving the bar code information for inventory control or pricing. The inventory tracking device communicates with an active signal response tag 14, for example, to receive from the tag a unique serial number associated with the particular book product 10.

Signal responsive tags 14 are conventional and available in different forms. EAS (electronic article surveillance) tags address product security needs. The signaling function responds passively to a general detection signal, for example, a signal communicated by a detector in a small area. The EAS tag is disabled at a cash register as discussed above. Similarly, the RF tag and AM acoustic magnetic tag also are passive as sensor-only devices for inventory theft control purposes. The RFID tag is a security device that contains a trackable sequence code, which code may be unique in order to track the specific product in which the RFID tag is installed. The RFID tag includes a microprocessor which may be programmed for inventory tracking and control purposes and a battery or other power supply. The RFID tag is active in that information transmits in from the interrogator device and may transmit responsive information out to the interrogator. For example, the interrogator may send a signal that essentially requests the tag to respond with the unique product sequence code. Thin-film RFID devices have thin, planar configurations or sheets, such as RAFSEC tags available from UPM Raflatac at www.upmraflatac.com

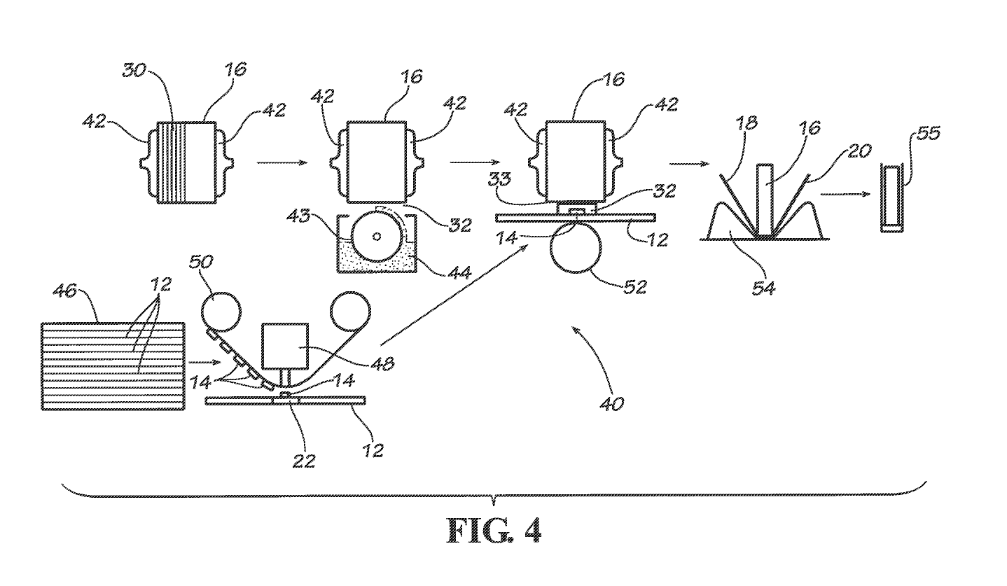

FIG. 4 illustrates a schematic block diagram 40 for manufacture of the book product 10. A pair of opposing clamp platens 42 holds the collated plurality of pages 30 to assemble the book block 16. A supply device or bath 43 holds a pool of a hot melt adhesive 44. A roller 45 passes through the pool and dispenses the hot melt adhesive to form the layer 32 of adhesive to the spine-side 33 of the book block 16.

A cover supply 46 holds a supply of the covers 12. A tag applicator 48 receives a web 50 that holds a plurality of tags 14. The tag applicator 48 detaches the tags 14 in sequence and deposits the detached tag onto the laydown area 24 on the spine portion 22 of the cover 12. Tag applicators are conventional and manufactured by a number of companies. Applicator devices that receive webs and detach tags are conventional. A presser 52 supports the cover 12 with the attached tag 14, and the inverted book block 16 is moved into contact with the cover 12 so that adhesive layer 32 attaches to the spine portion 22. A folding device 54 has a V-shaped tapering channel that as the book 10 passes through, the front cover 18 and back cover 20 fold upwardly to close the book 10 together 56. The assembled book 10 passes through a drying tower (not illustrated) and a knife trimmer to cut the book to size on the top, bottom and outer edge opposing the spine-side. A stacker (not illustrated) receives the closed book 55 and places the book in a stack of books for packaging, storing, and shipping.

FIG. 5 illustrates an alternate embodiment of the book product in which chipboard sheets 60 attach to an inner surface of the cover 12 in the front cover 18 and the back cover 20 portions. In the illustrated embodiment, an end leaf sheet 62 attaches to the sheet 60 to provide an ornamentally attractive appearance. The end leaf sheet 62 may include text or graphics, or be blank. Another alternate embodiment uses the end leaf sheets 62. Thus, the front and back covers 18, 20 may be multilayer laminated sheets, including paper sheet, plastic or film laminated sheets, liquid lamination, paper-based sheets, binder's board, chipboard, pasted chipboard or other suitable cover-forming material. Generally, the cover 12 material is nominally about 6 to 24 point but the thickness may be thicker, for example, selectively based on a particular application, as a single or multi-layer laminated sheet using pasted chipboard. For example, two 50-point chipboards may be pasted together to make a 100 point pasted chipboard, having increased mass and rigidity.

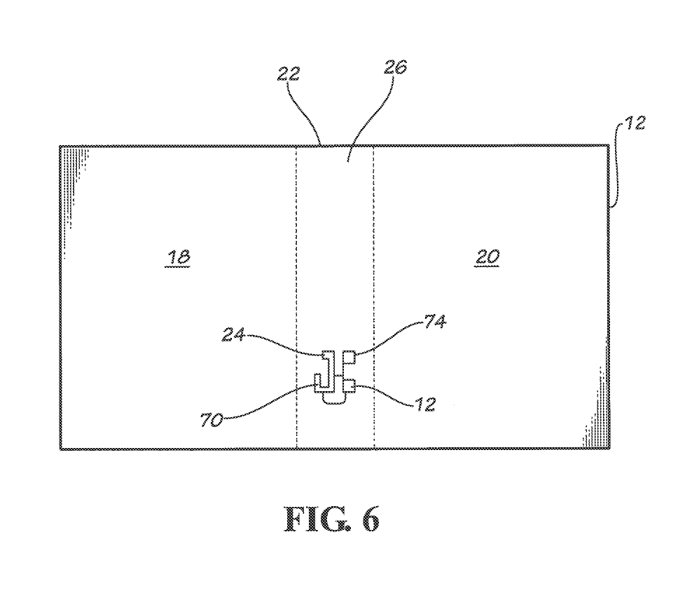

FIG. 6 illustrates an alternate embodiment of the signal responsive tag 14 applied to the spine portion 22 of the cover 12. This embodiment assembles the signal responsive tag 14 in situ by direct printing with a printer device of a circuit and an antenna 70 on the laydown area 24 using electrically conductive ink. A microprocessor chip 72 and battery 74 connect to the circuit 70. The label applicator 48 is replaced with a printer device configured for applying electrically conductive ink of a type known in the electronics circuit art for printing and encoding an RFID circuit with antenna for responding to radio frequency interrogation. A subsequent applicator places the microprocessor chip 72 and battery 74. In an alternate embodiment, however, the signal responsive tag 14 is an RFID device supplied as a thin-film patch or label on a web. An applicator detaches the RFID device (tag 14) and applies the device to the laydown area.

With reference to FIG. 1, the book product 10 assembled as discussed above conceals the signal responsive tag 14 between the spine portion 22 and the spine-side 33 of the book block 16 embedded within the adhesive layer 32 while nevertheless providing a uniformly thick layer of adhesive across the spine portion so that the tab is not readily detected by observation of the book product yet remains responsive to signals from interrogation devices for inventory and security purposes. For example, the book product 10 conceals the tag 14 from casual indication of its presence, such that a person giving ordinary attention would not be likely to detect the tag.

With reference to FIG. 4, the book product 10 assembles with the book block 16 having the adhesive layer 32 bonding or laminating to the spine portion 22 of the cover 12 to which the signal responsive tag 14 is attached. The pages 30 collate and are gripped by the pair of opposing clamp platens 42. Hot melt adhesive from the supply bath 44 is carried by the roller 45 and attaches to the spine-side 33 of the book block 16 to form the adhesive layer 32 on the spine-side.

A cover 12 moves from the supply 46. The tag applicator 48 detaches one of the tags 14 from the web 50 and applies the tag to the laydown area 24 in the spine portion 22 of the cover 12. As the hot melt adhesive begins to cool, the cover 12 with the attached signal responsive tag 14 moves into bearing contact with the adhesive layer 32. The adhesive layer 32 cooperatively holds the collated plurality of pages 30 and attaches to the cover 12 to assemble the book 10. The assembled book 10 passes through the folding device 54 and the front cover 18 and back cover 20 fold upwardly to close the book 10 together. The hot melt adhesive 32 finishes curing in the dryer and the knives trim the book 10 to a selected size. The stacker receives the closed book 10 and places the book in a stack of books for packaging, storing, and shipping.

The method of embedding the security device within the adhesive layer 32 may be gainfully used with hard cover book products as illustrated in FIG. 5. Chipboard sheets 60 attach to the front and back covers 18, 20, and may be covered with end leaf sheets 62 to provide an ornamentally attractive appearance. Another alternate embodiment uses only the end leaf sheets 62.

Thus, the front and back covers 18, 20 may be multilayer laminated sheets, including paper sheet, plastic or film laminated sheets, liquid lamination, paper-based sheets, chipboard, pasted chipboard or other suitable cover-forming material. Generally, the cover 12 material is nominally about 6 to 24 point but chipboard thickness may be thicker, for example up to about 56 point as a single or multi-layer laminated sheet (pasted chipboard). For example, two 50-point chipboards may be pasted together to make a 100 point pasted chipboard, having increased mass and rigidity.

The FIG. 6 illustrates the alternate embodiment in which the signal responsive tag comprises the microprocessor circuit and antenna 70, with the microprocessor chip 72 powered by a battery 74. The microprocessor 72 may be programmed to respond to an interrogation signal with information about the particular book, for example, respond by communicating a unique serial number assigned to the specific book.

It is to be appreciated that in an alternate embodiment, the signal responsive tag 14 attaches to the spine-side of the book block 16 prior to coating with the adhesive layer 32. The resulting book with concealed signal responsive tag 14 is not as satisfactory because the pressure sensitive adhesive 28 does not bind together the several of the pages over which the signal responsive tag 14 is positioned. Rather the adhesive 28 is in contact with the spine-side edge of these pages. That minority portion of the spine of the book occupied by the tag 14 would have the appearance and performance of a book not properly bound by the adhesive layer 32.

The concealed signal responsive tag 14 provides the book 10 with a device that responds to signals from an inventory or security system interrogation transmitter, yet the tag is not readily observable encased within the uniform appearing spine portion of the book, so as to avoid readily being detected visually by a person handling the book.

This specification has described the present invention that provides the book product with the signal responsive tag concealed within the book product including the steps necessary for making and using various embodiments thereof. It is to be understood, however, that numerous changes and variations may be made in the construction of the present book product within the spirit and scope of the present invention, and that modifications and changes may be made therein without departing from the scope thereof as set forth in the appended claims.

What is claimed is:

1. A book product, comprising:
a cover sheet pre-cut to a selected size and defining in portions thereof spaced apart opposing front cover and back cover for the book product, and defining a spine portion between the two portions for the front cover and the back cover, the spine portion defining a laydown area comprising less than a majority of the spine portion and a residual non-laydown area, the front cover and the back cover foldable along respective spaced-part lines defined by the spine portion;
a book block having a plurality of pages attached together with an first adhesive layer on a spine side of the book block and the adhesive layer cooperatively attached to the spine portion of the cover sheet;
a signal responsive tag for inventory or security purposes attached with a second adhesive layer to the spine portion in alignment with the laydown area of the spine portion, whereby the signal responsive tag is disposed between the spine portion and the spine side of the book block for concealing the signal responsive tag from casual indication of its presence and being held within the first adhesive layer after attachment of the book block to the outer cover safely and securely therein during manufacture of the book product and during normal use thereof for book product purposes;
the first adhesive layer between the spine portion and the spine side of the book block having a first thickness in the laydown area of the spine and a second thickness in the non-laydown area of the spine, the first thickness of adhesive less than the second thickness of adhesive and the first thickness of adhesive plus a thickness of the signal responsive tag substantially the same as the second thickness,
whereby the signal responsive tag being responsive to a signal while the opposing portions of the cover sheet that define the front cover and back cover are moveable together and apart foldably along the lines defined by opposing sides of the spine portion while supporting and enclosing the book block within the book product.

2. The book product as recited in claim 1, further comprising a coded indicia on an outer surface of the cover sheet in alignment with the laydown area.

3. The book product as recited in claim 1, wherein the signal responsive tag comprises a printed security device having a printed electrically conductive ink that defines a radio frequency circuit and antenna configured for responding to radio frequency signals.

4. The book product as recited in claim 3, wherein printed security device comprises a thin-film ink-circuit printed on inside surface of cover within the laydown area of the spine portion.

5. The book product as recited in claim 3, wherein the printed security device further comprises an electronic processor with memory programmable with a unique identification code for use in responding to a signal communicated by a radio frequency signal.

6. The book product as recited in claim 1, wherein the signal responsive tag is selected from group comprising an EAS, AM, RF, or RFID device.

7. The book product as recited in claim 1, further comprising a pair of end leafs and each attached to a respective inward planar surface of the portions of the cover sheet that defines the front and back covers of the book product.

8. The book product as recited in claim 1, further comprising a pair of a paper-based board each attached to a respective inward planar surface of the portions of the cover sheet that defines the front and back covers of the book product; and further comprising a pair of end leaf sheet that each overlays and attaches to a respective one of the pair of paper-based boards.

9. The book product as recited in claim 8, wherein the paper-based board is chipboard.

10. A method of manufacturing a book product, comprising the steps of:
(a) providing cover sheet pre-cut to a selected size and defining in portions thereof spaced-apart opposing front cover and back cover for the book product, and defining a spine portion between the two portions for the front cover and the back cover, the spine portion defining a laydown area and a residual non-laydown area, the front cover and the back cover foldable along respective spaced-part lines defined by the spine portion;
(b) attaching a signal responsive tag for inventory or security purposes to the spine portion in alignment with the laydown area of the spine portion
(c) binding a plurality of pages together with an adhesive layer applied on a spine side thereof to form a book block;
(d) cooperatively attaching the book block to the spine portion of the liner sheet so that the signal responsive tag is encased within the adhesive layer and held between the spine portion and the spine side of the book block in alignment with the laydown area of the spine portion during manufacture of the book product and during normal use thereof for book product purposes for concealing the signal responsive tag from casual indication of its presence, the adhesive layer thereafter having a first thickness in the laydown area of the spine and a second thickness in the non-laydown area of the spine, the first thickness of adhesive less than the second thickness of adhesive and the first thickness of adhesive plus a thickness of the signal responsive tag substantially the same as the second thickness,
whereby the signal responsive tag being responsive to a signal while the opposing portions of the cover sheet that define the front cover and back cover move together foldably along the lines defined by opposing sides of the spine portion for supporting and enclosing the bound assembly within the book product.

11. The method as recited in claim 10, further comprising the step of marking an exterior surface of the cover sheet in alignment with the laydown area with a coded indicia.

12. The method as recited in claim 10, wherein the step (b) attaching comprises printing on the laydown area of the spine portion of the cover a security device as the signal responsive tag having electrically conductive ink that defines a radio frequency circuit and antenna configured for responding to the signal communicated in a radio frequency signal.

13. The method as recited in claim 12, wherein the printed security device comprises a thin-film ink-circuit.

14. The method as recited in claim 12, wherein step (b) attaching further comprises providing the printed security device with an electronic processor with memory programmable with a unique identification code for use in responding to radio frequency signals.

15. The method as recited in claim 10, wherein the step (b) attaching comprises providing a selected one from the group comprising an EAS, AM, RF, or RFID device as the signal responsive tag.

16. The method as recited in claim 10, further comprising the step of attaching a pair of sheets to a respective planar surface in the portions of the outer liner defining the front and back covers of the book product.

17. The method as recited in claim 10, further comprising the step of attaching a respective one of a pair of a paper-based boards to a respective inward planar surface of the portions of the cover sheet that defines the front and back covers for the book product; and further comprising the step of providing a pair of end leaf sheets that each overlays and attaches to a respective one of the pair of boards.

18. The method as recited in claim 17, wherein the paper-based board in the attaching step comprises a chipboard sheet.

19. A book product, comprising:
a cover sheet pre-cut to a selected size and defining in portions thereof spaced-apart opposing front cover and back cover for the book product, and defining a spine portion between the two portions for the front cover and the back cover, the spine portion defining a laydown area comprising less than a majority of the spine portion and a residual non-laydown area, the front cover and the back cover foldable along respective spaced-part lines defined by the spine portion;
a book block having a plurality of pages attached together with an first adhesive layer on a spine side of the book block and the adhesive layer cooperatively attached to the spine portion of the cover sheet;
a signal responsive tag for inventory or security purposes attached with a second adhesive layer to the spine-side of the book block in alignment with the laydown area of the spine portion, whereby the signal responsive tag is disposed within the adhesive layer between the spine portion and the spine side of the book block for concealing the signal responsive tag from casual indication of its presence and being held within the first adhesive layer after attachment of the book block to the outer cover safely and securely therein during manufacture of the book product and during normal use thereof for book product purposes;
the first adhesive layer between the spine portion and the spine side of the book block having a first thickness in the laydown area of the spine and a second thickness in the non-laydown area of the spine, the first thickness of adhesive less than the second thickness of adhesive and the first thickness of adhesive plus a thickness of the signal responsive tag substantially the same as the second thickness,
whereby the signal responsive tag being responsive to a signal while the opposing portions of the cover sheet that define the front cover and back cover are moveable together and apart foldably along the lines defined by opposing sides of the spine portion while supporting and enclosing the book block within the book product.
